(19) United States
(12) Patent Application Publication
(10) Pub. No.: US 2012/0005231 A1
(43) Pub. Date: Jan. 5, 2012

(54) Document and Potential Evidence Management with Smart Devices

(75) Inventors: Samuel Beckey, San Ramon, CA (US); Joseph Fanelli, Escondido, CA (US); Christopher Blunden, San Ramon, CA (US)

(73) Assignee: Intelli-Services, Inc., San Ramon, CA (US)

(21) Appl. No.: 13/049,397

(22) Filed: Mar. 16, 2011

Related U.S. Application Data
(63) Continuation-in-part of application No. PCT/US2009/056849, filed on Sep. 14, 2009.
(60) Provisional application No. 61/097,392, filed on Sep. 16, 2008.

(51) Int. Cl. G06F 17/30

(52) U.S. Cl. 707/792; 707/E17.045

(57) ABSTRACT

A method and apparatus for document and potential evidence management with smart devices is provided. The method includes the steps of authorizing a smart device, verifying a user of the smart device. The smart device is then used to collect a document or piece of potential evidence. As part of the collection process, the user may apply an electronically registerable marking to the electronic record. The electronic record is then uploaded to a record repository. The record repository is a relational database that builds relationships among the documents and potential evidence using the markings applied during the collection process.

### PRIORITY CLAIM

This application is a bypass continuation-in-part application claiming priority under 35 U.S.C. 119 and 35 U.S.C. 365(c) from international patent application no. PCT/US09/56849 filed on Sep. 14, 2009, and U.S. provisional patent application No. 61/097,392 filed on Sep. 16, 2008, both of which are hereby expressly incorporated by reference herein.

### FIELD OF THE INVENTION

The present disclosure relates generally to secure electronic records and a method and apparatus for collecting and managing legal records using electronic and digital media at a remote location away from a secure electronic environment.

### BACKGROUND

The past decades have seen remarkable development of information technology. Nearly every facet of daily life and work is documented by electronic records unimaginable in earlier eras. From the typewriter to the computer, the way of work has changed, and become dependent on modem electronic technology. Many documents and work processes in many fields are now generated and stored electronically with paper records being relegated to off-site storage. Legal records, whether for litigation or for a patent application are diverse and often found in many forms. Some may be electronic, such as emails between employees, and research papers, contracts, or letters, while others may be paper records, such as pages from old laboratory notebooks or wills. Paper records are difficult to access, store, and may degrade over time. In contrast, electronic copies of paper records offer the ease of electronic filing and storage, and easy viewing on a monitor screen. Metadata allows for the creation of relational databases to allow access to related documents within a topic.

Despite the ease and convenience of electronic documents, there is a major drawback to their use in the legal environment: the validity of the documents. Because it is easy to create and modify electronic documents, it is difficult to ascertain whether an electronic document is a true and valid document. This is especially important for evidence to be submitted at trial, or evidence to document the date of reduction to practice for a patent application. The collection and management of documents during the discovery phase of a trial may involve vast numbers and types of documents and information from a wide variety of sources. Each document must be examined and processed as potential evidence, and the discovery process requires sharing responsive and non-privileged documents with opposing counsel and judge. Considerable risk may be involved as failure to produce a document may result in costly sanctions that may damage a client's case. The large number and types of documents creates an information management challenge. In preparation for a trial, lawyers, paralegals, court reporters, and subject matter experts are required to examine, categorize, and annotate documents. Reviewing personnel may label and note on the label specific details about the underlying document. Patent applications may require complete documentation of the inventive process with verifiable and reliable dates for the invention. Patent rights may be lost permanently if this information is missing or unreliable. Legal documents must have document integrity, however, given the vast numbers of documents that may be needed in a single trial there is a need to incorporate the many benefits of electronic filing and storage, both for record-keeping and for official submittals. It is also necessary to retrieve specific documents when needed.

Electronic records may be admitted in evidence to Federal Courts for use in court proceedings (see Federal Rules of Evidence 803(8)), if the record is trustworthy. Trustworthiness is established by a detailed and thorough documentation of the record keeping system's operation and the controls imposed on it. The records themselves may also need to be annotated and tagged or labeled for evidentiary purposes, and managed, all of which provide challenges for an information security system. Using a smart pen, it is possible for a legal reviewer to annotate the document while the formal electronic record is being created. However, the record created will not meet the trustworthiness standard required for admissible evidence because of the lack of security of the smart device used to collect the information and also because the electronic record may be modified or even deleted.

Recently, electronic laboratory notebooks, “smart pens” that transcribe notes directly into electronic form have come on the market, along with digital voice recorders, portable scanners, and cameras to name just a few smart devices for electronic document production away from a central electronic “home.” These smart devices enable the creation of electronic documents under a variety of settings and are easy to use and convenient. These smart devices are portable and may be used in a roaming mode away from a central computing area. Documents created by these smart devices are then downloaded to a central electronic vault or record repository upon return to a central office. The electronic vault or record repository, typically embodied as a server, represents one segment of a document management system. Legal documents once scanned or copied by one of these smart devices, whether in paper or electronic form, exist as islands of information, distinct and separate from secure computer environments. Multiple servers may be needed to handle the various types of electronic documents. The growing use of these smart devices poses a problem for the formal record keeping requirements in the legal profession, since most smart devices, or portable devices in general, offer minimal or no security. The importance of secure and trusted information systems requires security beyond that found in the typical smart device.

Creating a formal record requires more than a mere electronic copy of a paper record, or simply recording information. Formal electronic records must meet specific evidentiary requirements for integrity, user authentication, non-repudiation of the document, authorization of reviewing personnel, and may need to be kept confidential. This is at odds with the operation scenarios of most smart devices which are not connected to a secure computing environment during use. Smart devices used in conjunction with a secure computing system need to provide their own data security while used in a roaming mode away from a secure computing system. It is preferable that the smart device be verified with the secure computing system. The need for two way security is obvious: data transferred from a “smart device” that has no data security may corrupt the entire secure computing system and subject the system to debilitating virus or other computer security attacks. Thus, there is a need for a method and apparatus for providing secure electronic records in smart devices.

### BRIEF SUMMARY OF THE INVENTION

Techniques for document and evidence management with smart devices are provided. A smart device is first authorized. The user of the smart device is verified by providing a password, or keypad entry using a stylus, fingerprint, voice print or other unique personal identifier. The smart device is then used to collect an electronic record. The user applies an electronically registerable marking to the electronic record using the smart device or may mark a label with pre-printed electronic markings. Once the desired electronic records are collected and marked, the smart device is reconnected to a records repository which uploads the collected records, clears the authorization and prepares the smart device for the next record collection session.

An additional embodiment comprises collecting and marking at least one electronic record using a smart device. The collected and marked electronic device is uploaded to a record repository which builds a relational database using the collected and marked electronic records. The record repository uses the electronically registerable mark and other metadata to build the relationships among the collected electronic records.

Another embodiment provides an apparatus comprising a memory and a processor coupled with the memory. The processor is configured to authorize a smart device, and verify a user of the smart device. The apparatus may reside in the smart device. The processor is then used to collect and mark an electronic record with an electronically registerable mark. The processor then uploads the collected and marked records to a record repository.

Yet another embodiment provides a memory and a relational database. The relational database stores secure electronic records with electronically registerable markings. The relational database organizes the secure electronic records using the electronically registerable markings and other metadata.

A still further embodiment provides an apparatus comprising means for authorizing a smart device and means for verifying a user of a smart device. The apparatus further comprises means for collecting an electronic record using the smart device. Further means provide for applying an electronically registerable marking to an electronic record. Means are also provided to upload the collected and marked electronic record to a record repository.

An additional embodiment provides a processor readable medium including instructions that may be utilized by one or more processors. The instructions comprise instructions for authorizing a smart device and instructions for verifying a user of the smart device. The processor readable medium further provides instructions for collecting an electronic record using the device, and instructions for applying an electronically registerable marking to the electronic record. Additional processor readable instructions are provided for uploading the electronic record to a record repository.

An additional embodiment provides a processor readable medium including instructions that may be utilized by one or more processors. The instructions include: instructions for collecting and marking at least one electronic record using a smart device. Further instructions provide for collecting and marking at least one electronic record using the smart device. Still further instructions provide for creating a relational database with the marked electronic records using the marking information applied during electronic record collection.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an overview of legal electronic record collection and management according to an embodiment of the invention.

FIG. 2 is a block diagram of a system architecture for electronic legal record collection and management according to an embodiment of the invention.

FIG. 3 is a process overview of a method for legal electronic record collection and management according to an embodiment of the invention.

FIG. 4 is a flowchart of a method for legal electronic record collection and management according to an embodiment of the invention.

### DETAILED DESCRIPTION

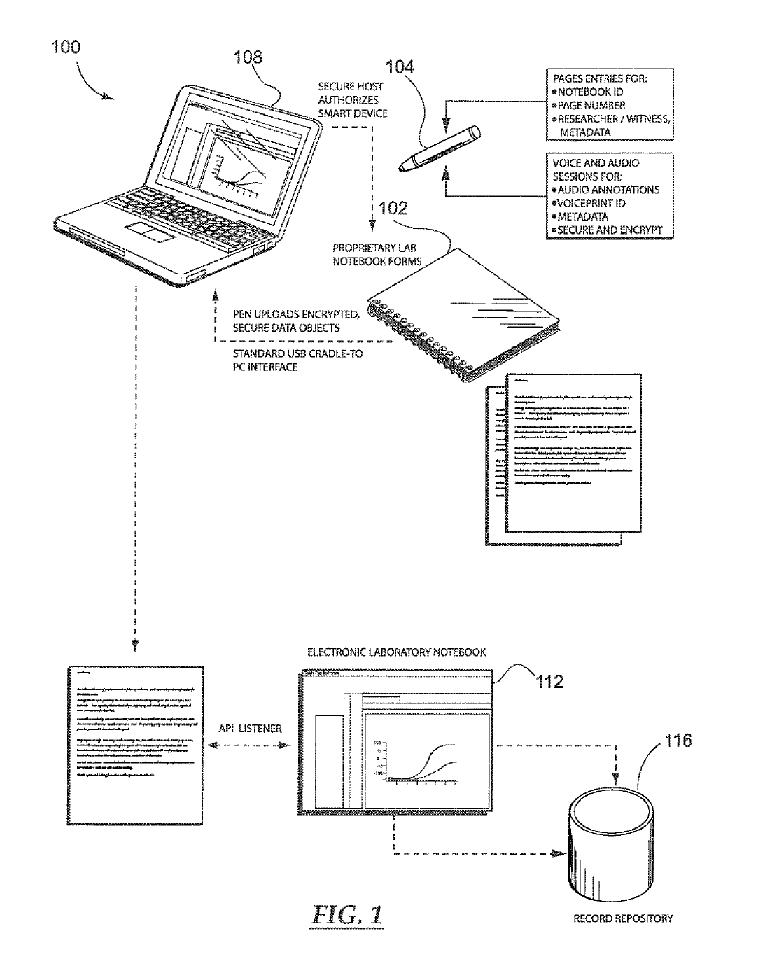

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident however, that such embodiment(s) may be practiced without these specific details. In other instances, well known structures and devices are shown in block diagram form in order to facilitate describing one or more embodiments. FIG. 1 illustrates a secure legal electronic record system 100 that provides secure use of smart devices in the legal environment. This secure system is designed to provide confidence that each data object, or secure electronic record created or collected by a smart device was collected by an authorized user (Authorization); has been maintained in the state in which it was originally created or collected (Integrity); cannot be copied or decoded except by the secure host (Confidentiality); is a record collected by a specific means, at a particular date and time (Authentication); and that the record cannot be erased or denied (Non-repudiation). Item 102 is proprietary forms or other evidence that may be copied electronically using a smart device. These forms will vary according to the type of case and the varieties of documents encountered. It may also be advisable to create common tags to enable use with metadata tracking systems that are part of many database protocols. The tags may incorporate bar codes or RFID tags and may provide blanks to be completed by the document reviewer. The electronic labels may be similar to evidence labels in paper form that have been used for years in the legal profession. These forms may be created or completed with a smart pen, item 104 that creates an electronic record while the user writes on the form. One embodiment uses smart pens such as the Pulse™ model manufactured by Livescribe, Inc. This smart device executes a computer program, such as a Java penlet application, to capture pen strokes and paper appearance. The program resident on the smart device provides interaction with the user to establish data security. Any computer program operating on the selected smart device that provides similar functionality may be used. The smart pen or device 104 is authorized prior to use by the secure host 108. Periodically, the smart pen or device is connected to a secure server, where it is authorized for a specific user and its identity is securely established. This connection occurs before each secure record collection or creation session. The interface between the pen and the secure host may be a standard USB interface, or other interface providing the desired functionality. Documents are stored in the secure host 108 for later use and viewing on laptop or other computers 112 or other similar devices. The laptop or other computer communicates with an electronic record repository 116. The laptop computer 112 may also be used as a smart device in the invention.

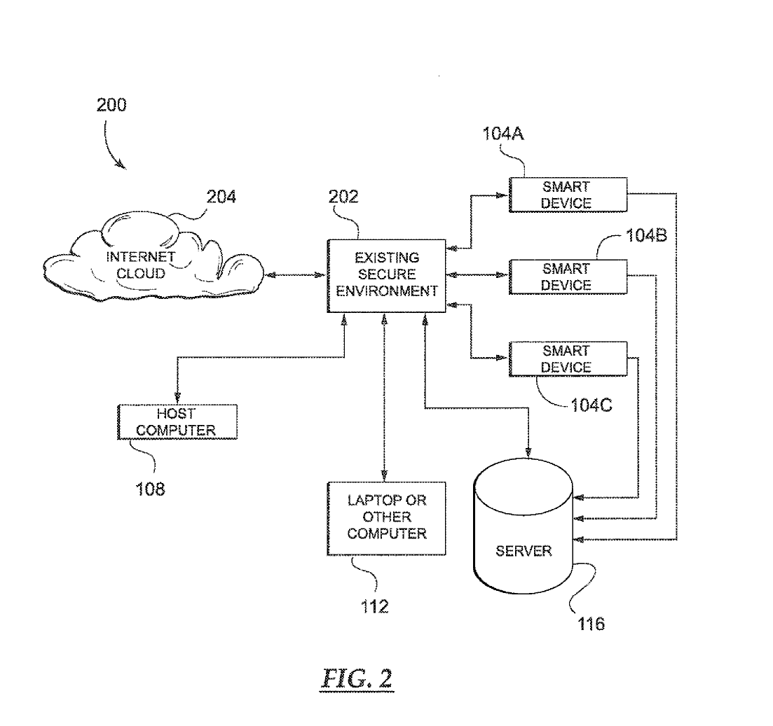

FIG. 2 illustrates a block diagram of the system depicted pictorially in FIG. 1. The block diagram of the system 200 shows the existing secure environment 202 connected to an Internet cloud 204. This arrangement allows for transfer of documents to other secure environments or to other trusted sites as would be necessary for legal and court document filings. The host computer 108 contains a processor and memory for running various software applications. The host computer 108 is also connected to the existing secure environment 202. A laptop computer 112 is connected to the existing secure environment as well. The laptop computer may also be used in conjunction with a smart device 104a-c. The smart devices are of various types such as smart pens, smart portable scanners, cameras or similar devices. Both the laptop computer 112 and smart devices 104a-c are connected electronically to a record repository, 116. The smart device 104a-c also includes a processor and memory for running applications specific to the type of data to be collected and for storing the collected records prior to upload to the record repository 116. These electronic interconnections provide secure functionality of the secure legal electronic records in smart devices according to the embodiments of the invention.

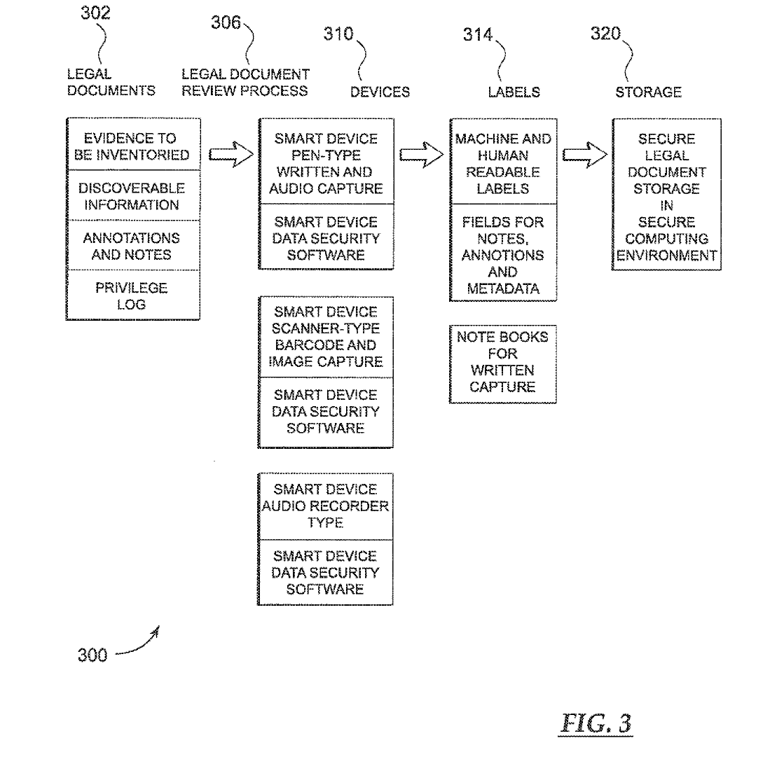

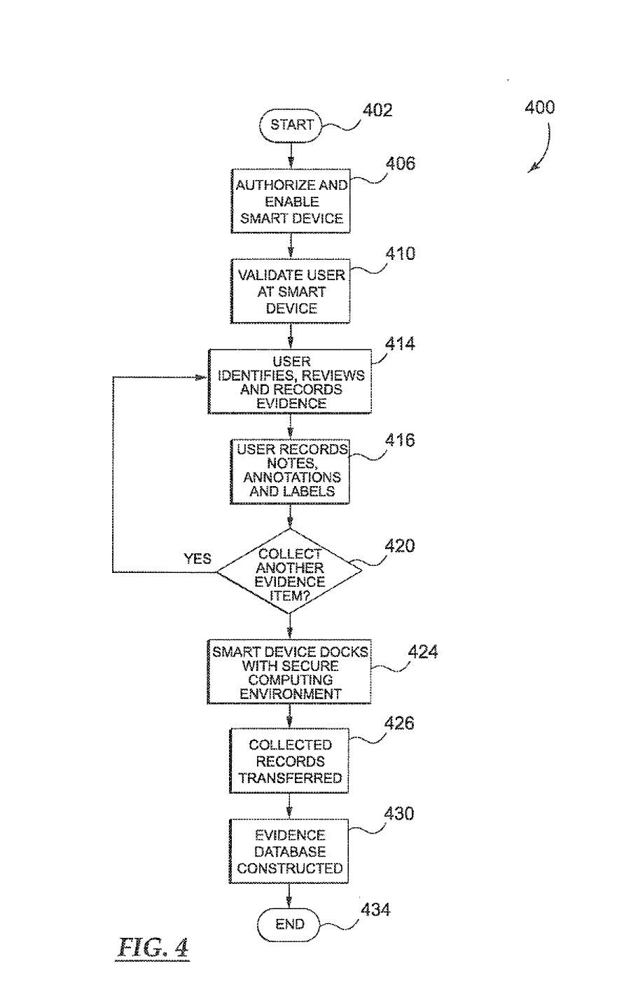

FIGS. 3 and 4 provide a block diagram overview of the process of reviewing and collecting secure legal electronic evidence and documents. FIG. 3 is a block diagram overview of the process illustrating the interaction of the various components, while FIG. 4 provides a flowchart of the process.

FIG. 3 provides a block diagram overview of the process of collecting and reviewing documents to create legal secure electronic evidence records. The legal documents, 302 may be evidence to be inventoried as well as discoverable information. A wide variety of document forms may be encountered, depending on the type of case or matter. Many pieces of evidence will still be in paper form, some will be in electronic data files, while further evidence may be physical objects that should be photographed. Each legal secure electronic record requires an assigned evidence number, typically written or printed on an adhesive label. Some documents may be considered privileged and are not required to be disclosed to parties outside the case. Normally, a privilege log records a list of documents covered by privilege. All of these records are interrelated. The legal document review process 306 requires a legal reviewer to study a piece of evidence and determine the relevance, importance, and context of the document. This is done by annotating a record attached to the evidence, which may be a label 314 with a barcode, RFID tag, or other identifying device. These document markers may be self-adhesive printed with a digitally legible dot pattern or other identification and may be similar to the commonly used “Bates labels” well known in the legal profession. Fields may be provided to classify the document and have space for further annotations. The reviewer records any annotations using a smart device 310, which may be of several types. One such smart device is a pen-type device that records keystrokes on an electronic copy of a label or form. An alternative embodiment uses a scanner to read a barcode or RFID type label. A further embodiment allows the use of an audio recorder to make voice notes concerning the document being reviewed. Evidence notebooks or logs are one method of tracking disparate pieces of evidence as well as documents. Devices similar to electronic laboratory devices or laptop computers could also serve as electronic evidence notebooks.

Once the document review has taken place the smart device is returned to the central office, where the secure electronic library storage 320, including the record repository 116 is located. The smart device records are uploaded and the device memory is cleared and prepared for the next use.

FIG. 4 illustrates the steps in the process of setting up and using a smart device to review and collect legal secure electronic records. The process 400 begins at step 402. The smart device must be authorized and enabled before being used to review and collect evidence. In step 406 the smart device is authorized and enabled. During this phase the smart device 104a-c is supplied with the specific software, tokens, credentials and authorization to use the device. The smart device connects with the secure host 108. When initially connected, the smart device 104ac requests a device connection from the secure host 108 and once that connection is established, the small device 104a-c reports its presence by sending a token. The token may be a unique device identity that allows for each smart device to be readily verified and known by the secure host. The secure host may maintain a list of smart devices for use in the secure environment. Alternatively, a smart device signature may be generated using an encrypted token that may be generated or stored on the smart device. This encryption may be accomplished through the use of a commercial encryption algorithm, such as Rivest-Shamir-Adleman (RSA), however, any encryption method may be used. The connection between the host computer 108 and the smart device 104a-c may be accomplished through the use of a number of device connection protocols, including but not limited to USB, Bluetooth, and WIFI. This exchange over the connection initiates the smart device 104a-c authorization. It is also possible to detect and prevent security violations even at this early stage of the process as the secure host 108 may prevent connection of an unauthorized, tampered, or malevolent smart device, by rejecting the device token and presenting an error or violation message.

Once the smart device 104a-c is connected and accepted by the secure host 108, the smart device 104a-c is loaded with at least one user credential for the upcoming formal record creation or collection session. The user credential mayor may not be the same as that used on the secure host computer 108. This credential is protected by the use of a one-way public key encryption that allows for comparison with user input during the validation phase. This prevents exposure of the user credentials by the smart device 104a-c.

As part of the authorization process the secure host 108 loads software on the smart device 104a-c. This software may be an assembly language program, an applet for a smart phone, or any other format supported by the smart device selected for use. The software incorporates internal validation processes and may also perform integrity checks on the smart device. It is this software that disables the smart device if the smart device is connected to any device other than the authorizing secure host.

The smart device 104a-c is authorized for a specific use, in this example, legal evidence review and annotation. Additional requirements for the particular use may also be included, such as a specific frequency of record collection, specific metadata to be collected, and an expiration time. The smart device 104a-c is generally authorized for a specific and limited period of time, after which a timeout occurs and data collection is prohibited by the smart device. Date and time information on the smart device 104a-c are also verified and corrected, and the condition of the device necessary to maintain its orientation is also verified. Depending on the nature of the smart device 104a-c, further information beyond that date and time are available and may also serve as useful metadata to establish the integrity of the data records collected.

Once the smart device 104a-c has been authorized, the device is ready for use. Upon completion of the authorization process, the smart device 104a-c is secure and protected from unauthorized use. The smart device software is ready to collect or create records and successfully encrypt, secure and protect the collected records.

The smart device is authorized and enabled and is nearly ready for use in reviewing and collecting evidence or other documents. Before secure legal record collection begins the user must be validated on the smart device, step 410. The evidence review and collection session begins when the user logs into the smart device 104a-c, to validate that the user is permitted to use the device. This user validation typically consists of a user logging in with a user name or password provided by the existing secure environment, 202. The smart device 104a-c may have various ways of receiving entries from users. The user may enter the information via a keypad, a touch stylus on a tablet, supply a thumbprint or fingerprint, or may provide a voice print. It is conceivable that a retina scan may be used as well. If a touch stylus is used, direct entry of the user's signature may provide the log in for user validation. The smart device 104a-c may record each access attempt for security purposes. For additional security, a secondary validation may be required by the secure environment 202. This secondary validation may be processed later by secure host 108 during the uploading of data from the smart device 104a-c, upon completion of the record collection session. The secondary validation may take any of the forms of validation above and for added security different forms of validation may be selected. Based on the validation information provided by the user, the smart device 104a-c then calculates and pre-authorizes a session for that user on that smart device 104a-c. This preauthorization process creates a token to be used for secure encryption of the formal electronic record being created.

The user then begins creating a formal record using the smart device 104a-c in step 414. The user identifies, reviews, records, and annotates as the evidence or document is reviewed. The user may access pre-printed forms, such as labels, on the smart device 104a-c, or may apply prepared labels with barcodes or RFID tags, make annotations, and record the annotations in step 416. The smart device 104a-c initiates a timer or clock when secure electronic record creation or collection begins in step 414. Each smart device 104a-c is authorized for a specific period of time to collect secure electronic records and ceases to allow record creation once the timer or clock has expired. While the user is creating secure electronic records, the smart device 104a-c process each record or page by wrapping each record in a secure wrapper. The smart device 104a-c applies hashing, such as SHA-1 hashing, to the records and may further encrypt the data for additional security. Each data record is contained in a wrapper, which may be in XML format, so that relevant metadata is included for each record. This allows for secure electronic records to be tied to a particular smart device 104a-c and a particular user. The metadata is used to collect and reference each piece of evidence or record relevant in the case. The records may be an audio recording, scan of a written page, pen stokes of a smart pen, bar codes for inventory data, visual images from a camera, magnetic stripe data as found on credit cards, RFID tags, or a combination of data types. The smart device 104a-c may also provide for annotations on each secure electronic record as it is created. These annotations may be in the form of voice notes or notes made with a smart pen. This process occurs during the time that the smart device 104a-c is disconnected and independent from the existing secure environment 202. During the secure record collection and creation process, the smart device 104a-c will not allow deletion or modification of secure electronic records by the user.

Collection of secure electronic records may be modified from that described above, based on the needs of the record user. Authentication and non-repudiation are accomplished through the use of the software contained on the smart device 104a-c. The software on the smart device 104a-c validates itself before operation and use, which assures continued operation. This allows for programming flexibility, such as providing a playback feature to allow smart device users to check a collected secure record before leaving a remote record storage location. This would be especially helpful for record collection at off-site storage locations, where returning may not be possible.

Upon completion of a secure electronic record the smart device 104a-c checks whether the device is still in use. This is useful in case the user walks away from the device or sets it down temporarily. The smart device 104a-c will then check to see if the timeout clock expired in step 420 and whether the user wishes to collect another evidence item. If the timeout clock has not expired, the user may make another record and the process returns to step 414. The process repeats as long as the user continues to create secure electronic records and the timeout clock has not expired. If the timeout clock has expired, the smart device 104a-c authorization expires. With the expiration of the authorization, the smart device 104a-c may not be used to collect evidence or legal secure electronic records.

Once the secure electronic records have been collected the records must be transferred to the existing secure environment 202. In step 424 the smart device 104a-c is reconnected to the existing secure environment 202. Upon connection, the secure host 108 verifies that the smart device 104a-c is a previously authorized data collection device. The smart device 104a-c may also report to the secure host 108 using a unique token. The unique identity of the smart device 104a-c is checked against a list of authorized smart devices 104a-c maintained on the secure host 108. The secure host has a record of all authorized devices and their expected data collection activities. This allows for detection of exceptions to the list of smart devices 104a-c. An exception may be a smart device 104a-c that failed to return to the secure environment during a preauthorized period, or a device that detected tampering, a login failure, or other potentially malevolent activity. During the connection to the secure host 108, the smart device 104a-c reports its user credentials, allowing a report to be generated indicating which users successfully recorded secure electronic records. This forms a type of security log for the smart device 104a-c. For additional security the smart device 104a-c may be required to return to the same secure host 108 that authorized the device for any uploading.

The secure host 108 verifies that the smart device 104a-c authorization is still valid. The secure host 108 then verifies the user, and the user's login or validation information. Once the smart device 104a-c has been successfully connected and verified the transfer of the collected secure legal electronic records begins in step 426. The transfer process also requires that the secure host 108 decrypt the wrapper added to the secure electronic record at the time of collection. Each record on the smart device 104a-c is encrypted in such a way that the record cannot be decrypted while resident on the smart device 104a-c. The secure electronic record must be decrypted with a private key maintained on the secure host 108. If playback capability on the smart device 104a-c is desired, playback capability may be achieved through the use of redundant information kept on the smart device 104a-c in an unencrypted file. This provides for secure and uncorrupted records transmission to the existing secure environment 202.

With all collected secure legal electronic records have been uploaded to the secure host 108, the secure host 108 clears the smart device 104a-c of records, revokes the authorization, and returns the smart device 104a-c to authorization and enabling state. The collected and transferred evidence records, or secure legal electronic records are transferred into the record repository 116. The metadata on the collected legal secure electronic records allows for a relational database of all the evidence and records in the case to be constructed in step 430. The process ends at step 434. Because the database utilizes metadata collected with the evidence it is possible to generate summaries and concordances of the various pieces of evidence in the case, along with reviewer impressions and ratings of document relevance.

Thus, it is seen that a method and apparatus for document and evidence collection and management is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to various partitions. Additionally, in regard to flow diagrams, operational description and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the inventions, whether or not such embodiments are described and whether or not such features are presented as being a part of a described embodiment. Thus, the breadth and scope of the present invention should not be limited by any of the above-described embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, tradition, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is expressly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The techniques described herein may be implemented by various means. For example, these techniques may be implemented in hardware, firmware, software, or a combination thereof. For a hardware implementation, the processing units may be implemented within one or more application specific integrated circuits (ASICS), digital signal processors (DSPs), digital signal processing devices, (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques may be implemented with instructions (e.g. procedures, function, and so on) that perform the functions described herein. The instructions may be stored in a memory in the secure host 108 or the smart device 104a-c. The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method comprising:
authorizing a smart device;
verifying a user of the smart device;
collecting an electronic record using the smart device;
applying an electronically registerable marking to the electronic record; and
uploading the electronic record to a record repository.

2. The method of claim 1, wherein applying a marking to the electronic record comprises applying a label having a machine-readable mark.

3. The method of claim 2, further comprising annotating the label having a machine-readable mark using a smart device.

4. The method of claim 2, further comprising making a voice annotation on the electronic record using a smart device.

5. A method comprising:
collecting and marking at least one electronic record using a smart device;
uploading the at least one marked electronic record from the smart device to a record repository; and
creating a relational database with the at least one marked electronic record using marking information applied to the at least one electronic record during collection.

6. An apparatus comprising:
a memory; and
a processor coupled with the memory, the processor configured to authorize a smart device, verify a user of the smart device, collect an electronic record, apply an electronically registerable mark, and upload the electronic record to a record repository.

7. An apparatus comprising:
a memory; and
a relational database storing secure electronic records having electronically registerable markings applied to the secure electronic records, the relational database organizing the secure electronic records based on the electronically registerable markings.

8. An apparatus comprising:
means for authorizing a smart device;
means for verifying a user of the smart device;
means for collecting an electronic record using the smart device;
means for applying an electronically registerable marking to the electronic record; and
means for uploading the electronic record to a record repository.

9. An apparatus comprising:
means for collecting and marking at least one electronic record using a smart device;
means for uploading the marked at least one electronic record from the smart device to a record repository; and
means for creating a relational database with the at least one marked electronic record using marking information applied to the at least one electronic record during collection.

10. A processor readable medium including instructions thereon that may be utilized by one or more processors, the instructions comprising:
instructions for authorizing a smart device;
instructions for verifying a user of the smart device;
instructions for collecting an electronic record using the smart device;
instructions for applying an electronically registerable marking to the electronic record; and
instructions for uploading the electronic record to a record repository.

11. A processor readable medium including instructions thereon that may be utilized by one or more processors, the instructions comprising:
instructions for collecting and marking at least one electronic record using a smart device;
instructions for uploading the marked at least one electronic record from the smart device to a record repository; and
instructions for creating a relational database with the at least one marked electronic record using marking information applied to the at least one electronic record during collection.
